(19) United States
(12) Patent Application Publication
(10) Pub. No.: US 2023/0328187 A1
(43) Pub. Date: Oct. 12, 2023

(54) NON-TRANSITORY COMPUTER READABLE RECORDING MEDIUM RECORDING PROGRAM, INFORMATION PROCESSING APPARATUS, AND INFORMATION PROCESSING METHOD

(71) Applicant: FUJIFILM Business Innovation Corp., Tokyo (JP)

(72) Inventor: Kohshiro INOMATA, Kanagawa (JP)

(73) Assignee: FUJIFILM Business Innovation Corp., Tokyo (JP)

(21) Appl. No.: 18/177,129

(22) Filed: Mar. 2, 2023

(30) Foreign Application Priority Data
Mar. 29, 2022 (JP) 2022-053945

(51) Int. Cl. H04N 1/00

(52) U.S. Cl. CPC H04N 1/0044; H04N 1/00029

(57) ABSTRACT

A non-transitory computer readable recording medium records program for causing a computer to implement: a function of displaying a preview image of a document instructed to be output prior to execution of output of the document in a case where a content of the document satisfies a predetermined condition; and a function of permitting the execution of output of the document in a case where confirmation by a user of the preview image displayed is detected.

### CROSS-REFERENCE TO RELATED APPLICATIONS

This application is based on and claims priority under 35 USC 119 from Japanese Patent Application No. 2022-053945 filed Mar. 29, 2022.

### BACKGROUND

### (I) Technical Field

The present invention relates to a non-transitory computer readable recording medium recording program, an information processing apparatus, and an information processing method.

### (II) Related Art

An error may be found after an email is sent or printed. In order to solve such a problem, JP2010-147569 A discloses an image forming apparatus capable of setting forced display of a preview image for each user or each operation. Further, JP2011-120264 A discloses an image transmission apparatus that forcibly displays a preview image according to a transmission destination in order to prevent erroneous transmission.

However, in the above-described techniques, since the preview image is displayed regardless of correctness or incorrectness, the preliminary confirmation of the user by the display of the preview image gradually becomes perfunctory, and the original purpose is not achieved.

### SUMMARY

Aspects of non-limiting embodiments of the present disclosure relate to a non-transitory computer readable recording medium recording program enhancing the effect of suppressing erroneous transmission and erroneous printing, as compared with a case where a preview image is displayed regardless of correctness or incorrectness.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable recording medium recording program for causing a computer to implement: a function of displaying a preview image of a document instructed to be output prior to execution of output of the document in a case where a content of the document satisfies a predetermined condition; and a function of permitting the execution of output of the document in a case where confirmation by a user of the preview image displayed is detected.

### BRIEF DESCRIPTION OF THE DRAWINGS

FIG. 1 is a conceptual diagram of an image forming system according to a first exemplary embodiment.

FIG. 2 is a diagram illustrating a hardware configuration of a user terminal.

FIG. 3 is a diagram illustrating a functional configuration of a user terminal used in the first exemplary embodiment.

FIG. 4 is a flowchart illustrating an example of a processing operation according to the first exemplary embodiment.

FIG. 5 is a flowchart illustrating an example of a determination operation executed in step 2.

FIG. 6 is a flowchart illustrating an example of a processing operation executed in step 3.

FIG. 7 is a diagram illustrating a case where a preview image of a target document does not need to be displayed.

FIG. 8 is a diagram illustrating a display example of a part of a preview image displayed on a display device.

(A) illustrates a display state at the start of confirmation, (B) illustrates a display state during confirmation, and (C) illustrates a display state at the end of confirmation.

FIG. 9 is a diagram illustrating a remaining display example of the preview image displayed on the display device.

(A) illustrates an operation state of the “confirmation completion” button, and (B) illustrates a display example of a preview image subsequent to the operation of the “confirmation completion” button.

FIG. 10 is a diagram illustrating a functional configuration of a user terminal used in a second exemplary embodiment.

FIG. 11 is a flowchart illustrating an example of a processing operation according to the second exemplary embodiment.

FIG. 12 is a flowchart illustrating an example of a determination operation executed in step 2A.

FIG. 13 is a diagram illustrating an example of a format of a target document.

FIG. 14 is a diagram illustrating an example of correction omission. (A) illustrates an example of a previous document having the same file name, and (B) illustrates an example of a current document having the same file name.

FIGS. 15A to 15C are diagrams each illustrating a display example of a preview image according to the second exemplary embodiment. FIG. 15A illustrates an example in which a correction candidate is displayed at a portion having a possibility of correction omission, FIG. 15B illustrates an example in which the portion having the possibility of correction omission is displayed so as to be distinguishable from other portions, and FIG. 15C illustrates an example in which only the portion having the possibility of correction omission is displayed in an enlarged manner.

FIG. 16 is a diagram illustrating a functional configuration of a user terminal used in a third exemplary embodiment.

FIGS. 17A and 17B are a diagram each illustrating tracking of a direction of a line of sight of a user who views a preview image. FIG. 17A illustrates a case where the user is viewing the left side (right side of the preview image), and FIG. 17B illustrates a case where the user is viewing the right side (left side of the preview image).

FIG. 18 is a diagram illustrating another display example of the preview image displayed on the display device.

(A) illustrates the position and display state of the line of sight at the start of confirmation, (B) illustrates the position and display state of the line of sight during confirmation, and (C) illustrates the position and display state of the line of sight at the end of confirmation.

FIG. 19 is a conceptual diagram of a network system according to a fourth exemplary embodiment.

FIG. 20 is a conceptual diagram of a network system according to a fifth exemplary embodiment.

FIG. 21 is a diagram illustrating a hardware configuration of an image forming apparatus.

### DETAILED DESCRIPTION

Hereinafter, exemplary embodiments of the present invention will be described with reference to the drawings.

### First Exemplary Embodiment

### <System Configuration>

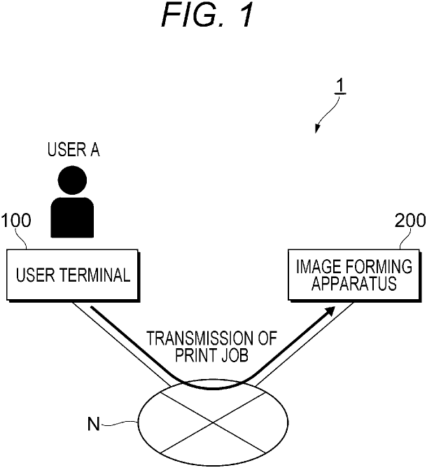

FIG. 1 is a conceptual diagram of an image forming system 1 according to a first exemplary embodiment.

The image forming system 1 illustrated in FIG. 1 includes a user terminal 100 and an image forming apparatus 200 that are communicably connected to each other via a network N.

The network N includes a mobile communication system such as a local area network (LAN), the Internet, 4G, or 5G. The network N is not limited to a wired network, and may be a wireless network.

Although one user terminal 100 and one image forming apparatus 200 are connected to the network N in FIG. 1 for convenience of explanation, a plurality of user terminals 100 and a plurality of image forming apparatuses 200 may be connected to the network N.

The user terminal 100 is a terminal operated by a user A, and is an example of an information processing apparatus.

The user terminal 100 in the present exemplary embodiment is a so-called computer.

The user terminal 100 may be a stationary computer or a portable computer.

The stationary computer is also referred to as a desktop computer.

Examples of the portable computer include a tablet type computer, a notebook type computer, a head mount type computer, a spectacle type computer, a wearable type computer, and a portable type computer. Examples of the portable type computer include a mobile phone and a smartphone.

The user terminal 100 has a function of transmitting a print job to the image forming apparatus 200 via the network N.

The print job is a job for instructing printing of a document. One print job includes a data file (hereinafter also referred to as “document data”) corresponding to a document to be printed. The document data may have any data format.

The documents in data format include an electronic document generated by an application program (hereinafter referred to as “application”) and a digital document generated from a paper document.

Examples of the electronic document include electronic data generated by a so-called office application, electronic data generated by a drawing application, electronic data generated by an accounting application, and a web page displayed on an application (that is, a browser) for browsing a website.

Examples of the digital document include electronic data output from a scanner and electronic data output from a camera.

“Print” is an example of “output” by the user terminal 100. Accordingly, the “print instruction” is an example of an “output instruction”.

The image forming apparatus 200 is an apparatus that forms an image on paper or another medium. The image forming apparatus 200 specialized for image formation (hereinafter referred to as “printing”) is also referred to as a “printer”.

The image forming apparatus 200 may have a copy function of generating a copy of a document, a scanner function of optically reading an image of a document, and a fax function, in addition to a print function. The image forming apparatus 200 having a plurality of functions is also referred to as a “multifunctional device”.

The image forming apparatus 200 may be used for business or home.

### <Configuration of User Terminal>

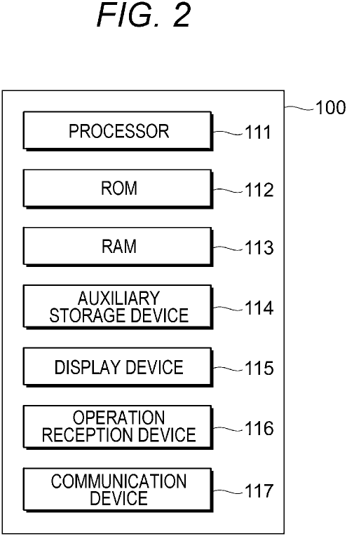

FIG. 2 is a diagram illustrating a hardware configuration of the user terminal 100.

The user terminal 100 illustrated in FIG. 2 includes a processor 111 that controls an operation of the entire apparatus, a read only memory (ROM) 112 that stores a basic input output system (BIOS) and the like, a random access memory (RAM) 113 that is used as a work area of the processor 111, an auxiliary storage device 114 that stores data such as a program, a display device 115 that displays information, an operation reception device 116 that receives a user operation, and a communication device 117 that is used for external communication.

The processor 111, the ROM 112, and the RAM 113 function as a so-called computer.

The processor 111 implements various functions through execution of a program. Here, the program is a general term for an operating system (OS), a BIOS, and an application. One of the various functions is a function of selectively executing preview display before transmission of a print job.

The processor 111 and each unit are connected by a bus or other signal lines.

Examples of the auxiliary storage device 114 include a semiconductor memory and a hard disk drive. In the auxiliary storage device 114, data files corresponding to programs and print jobs are stored.

The display device 115 is, for example, a liquid crystal display or an organic EL display. The display device 115 does not have to be integrated with the device main body of the user terminal 100, and may be a device externally attached to the device main body.

The operation reception device 116 receives a user operation. Examples of the operation reception device 116 include a capacitive touch sensor disposed on a display surface of the display device 115, a physical switch or button, a keyboard or other input devices, and a mouse or other pointing devices. In a case where the user operation is received as the gesture, a camera is used as the operation reception device 116.

A device in which the display device 115 and the operation reception device 116 are integrated is called a touch panel. The touch panel is used to receive a user operation on a key displayed on the display device 115 in terms of software.

The communication device 117 is a device that implements communication with the network N, and includes modules conforming to a wired or wireless communication standard. Examples of the communication device 117 include an Ethernet (registered trademark) module, a universal serial bus (USB) module, and a wireless local area network (LAN) module.

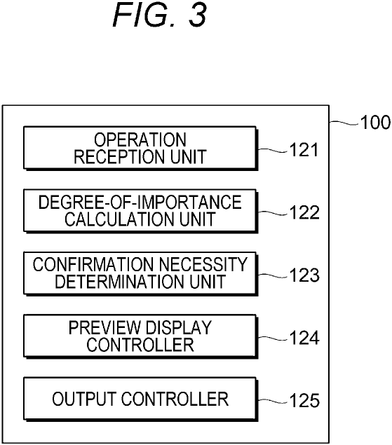

FIG. 3 is a diagram illustrating a functional configuration of the user terminal 100 used in the first exemplary embodiment.

Functional units illustrated in FIG. 3 are implemented through the execution of a program by the processor 111 (see FIG. 2).

The functional units illustrated in FIG. 3 are an operation reception unit 121, a degree-of-importance calculation unit 122, a confirmation necessity determination unit 123, a preview display controller 124, and an output controller 125.

The operation reception unit 121 is the functional unit that receives printing of a document. The operation reception unit 121 receives an operation of the print button as a print instruction.

The degree-of-importance calculation unit 122 is the functional unit that calculates the degree of importance of a document specified as a target to be printed (hereinafter referred to as a “target document”). The degree of importance here means the degree of necessity of confirmation by the user before the transmission of the print job. The target document is an example of a document to be output.

In the present exemplary embodiment, a document that is highly required to be confirmed is referred to as a document having a high degree of importance, and a document that is less required to be confirmed is referred to as a document having a low degree of importance. In the present exemplary embodiment, the numerical value representing the degree of importance is larger as the degree of importance is higher, and is smaller as the degree of importance is lower. The numerical value representing the degree of importance is an example of an evaluation value.

The degree-of-importance calculation unit 122 outputs a value larger than a reference value for determination in a case where, for example, a character, a symbol, a figure, and an image that are registered in advance (hereinafter, also referred to as a “character and the like”) are included in the target document, and outputs a value smaller than the reference value for determination in a case where the character and the like registered in advance are not included in the target document.

Examples of the character registered in advance include “confidential”, “important”, “order form”, and “contract”. Examples of the symbol registered in advance include a five star mark, an important mark, and a double circle mark. Examples of the figure or image registered in advance include a company logo, a stamp of a company mark, and a secret stamp.

For example, in a case where the reference value is “3”, “5” is output as a value larger than the reference value for determination, and “0” is output as a value smaller than the reference value for determination.

It should be noted that the degree-of-importance calculation unit 122 may calculate the number of character and the like, which are registered in advance and included in the target document, as the numerical value representing the degree of importance. For example, if the target document includes two characters registered in advance and three figures registered in advance, the degree-of-importance calculation unit 122 outputs “5” as the numerical value representing the degree of importance. However, the number may be the number of different character and the like.

The numerical value here is the same as the sum of weights in a case where the weight assigned to the character registered in advance is “1”.

Alternatively, the degree-of-importance calculation unit 122 may calculate the sum of weights assigned to the character and the like, which are registered in advance and included in the target document, as a numerical value representing the degree of importance. For example, in the case where the target document includes the character “confidential” and the figure of “company logo”, and “3” is assigned as the weight of each of the character “confidential” and the figure of “company logo”, the degree-of-importance calculation unit 122 outputs “6” as the numerical value representing the degree of importance.

The numerical value representing the degree of importance may increase or decrease in accordance with the type of the target document. The type may be identified from, for example, the file name of the target document or the title of the document, or may be identified from the format of the document.

The format is also referred to as a form or formatting. The format of the document may be specified by, for example, the shape and arrangement of a frame line, specific characters and arrangement, and the like.

For example, when the target document is an order form or a contract, a constant may be added to or multiplied to the calculated numerical value. On the other hand, when the target document is a sample, a test plate, or the like, a constant may be subtracted from the calculated numerical value, or the calculated numerical value may be divided by the constant. The constant here is an example of a weight.

In the case of the plurality of times of print instruction for the same document, the degree-of-importance calculation unit 122 may set the degree of importance to “0” without calculating the sum of weights, or may add a negative weight to the sum of weights. The negative weight may be a fixed value regardless of the number of instructions, or may be increased according to the number of instructions.

The degree-of-importance calculation unit 122 may reduce a constant to be multiplied to the calculated numerical value in accordance with the number of print instructions for the same document. For example, “0.5” may be multiplied in the case of the second print instruction for the same document, and “0.25” may be multiplied in the case of the third print instruction for the same document.

The addition of the negative weight or the multiplication of the constant less than 0 is an example of correction of the calculated numerical value.

The confirmation necessity determination unit 123 is the functional unit that determines the necessity of confirmation of the target document by the user before transmission of the print job to the image forming apparatus 200. In other words, the confirmation necessity determination unit 123 is the functional unit that determines the necessity of displaying the preview image corresponding to the target document before transmission of the print job to the image forming apparatus 200.

The confirmation necessity determination unit 123 determines the necessity of the confirmation by comparing the calculated numerical value of the degree of importance with a reference value, for example.

In the present exemplary embodiment, if the calculated numerical value of the degree of importance is higher than the reference value, the confirmation necessity determination unit 123 determines that confirmation is necessary. On the other hand, if the calculated numerical value of the degree of importance is lower than the reference value, the confirmation necessity determination unit 123 determines that the confirmation is unnecessary.

A case where the calculated numerical value of the degree of importance is higher than the reference value is an example of a case where a predetermined condition is satisfied. A case where the calculated numerical value of the degree of importance is lower than the reference value is an example of a case where the predetermined condition is not satisfied.

It should be noted that the confirmation necessity determination unit 123 may determine the necessity of the confirmation based on the information on the application that gives an instruction to print the target document and the information on the necessity of maintaining the sameness.

For example, if the application that has given the instruction to print the target document is a specific application, the confirmation necessity determination unit 123 may determine that the confirmation is necessary, and if the application is not a specific application, the confirmation necessity determination unit 123 may determine that the confirmation is unnecessary.

Examples of the specific application include a browser. The specific application can be set in advance by the user.

For example, if the target document does not require the sameness, the confirmation necessity determination unit 123 may determine that the confirmation is necessary, and if the target document requires the sameness, the confirmation necessity determination unit 123 may determine that the confirmation is unnecessary.

The documents requiring sameness may include not only documents that are not supposed to be edited but also documents that are less likely to be edited. These documents can be determined from the extension of the data file.

For example, if the extension of the data file corresponding to the target document is “pdf” or “xdw”, the confirmation necessity determination unit 123 determines that the target document is a document requiring sameness. In the documents with these extensions, characters, figures, tables, and the like are arranged in the same manner as printed matter.

If the application that has given the instruction to print the target document is a specific application or if the target document is a document for which the sameness is required, the confirmation necessity determination unit 123 may stop the calculation of the degree of importance by the degree-of-importance calculation unit 122.

In other words, if the application that has given an instruction to print the target document is not a specific application, or if the target document is a document for which the sameness is not required, the confirmation necessity determination unit 123 may give the target document to the degree-of-importance calculation unit 122 to calculate the degree of importance.

The preview display controller 124 is the functional unit that controls display of a preview image of the target document. The preview display controller 124 displays the preview image of the target document if the confirmation necessity determination unit 123 determines that the target document needs to be confirmed, and does not display the preview image of the target document if the confirmation necessity determination unit 123 determines that the target document does not needs to be confirmed.

The preview display controller 124 has a function of displaying an operator for closing the preview image of the target document when it is estimated that confirmation of the entire preview image of the target document is completed. In other words, the preview display controller 124 does not display the operator for closing the preview image until it is estimated that confirmation of the entire preview image of the target document is completed.

The completion of the confirmation of the entire preview image of the target document is determined by, for example, the path of the movement of the mouse cursor. For example, in a case where the entire preview image is filled with the path of the mouse cursor, it is determined that confirmation of the entire preview image is completed. The term “fill” used herein does not mean “without a gap”, but may mean tracing the entire outline of the target document.

The preview display controller 124 does not consider that confirmation of the entire preview image has been completed simply by moving the mouse cursor linearly from one end to the opposite end of the preview image.

The output controller 125 is the functional unit that controls transmission of a print job.

If the confirmation necessity determination unit 123 determines that the confirmation of the target document by the user is unnecessary, the output controller 125 transmits the print job corresponding to the target document to the image forming apparatus 200 (see FIG. 1) without delay.

On the other hand, if the confirmation necessity determination unit 123 determines that the confirmation of the target document by the user is necessary, the output controller 125 detects that the user has confirmed the entire target image with the preview image, and does not transmit the print job corresponding to the target document to the image forming apparatus 200 (see FIG. 1) until the output controller 125 further detects that the user has instructed to print.

That is, the output controller 125 transmits the print job corresponding to the target document to the image forming apparatus 200 only when detecting that the user has confirmed the entire target document with the preview image and further detecting that the user has instructed to print.

### <Processing Operation when Print Instruction is Received>

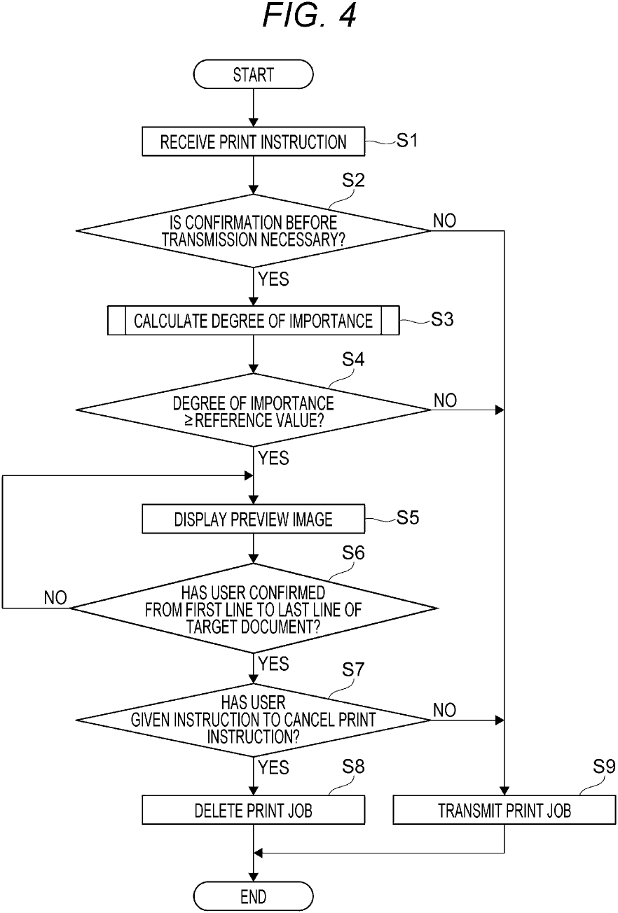

FIG. 4 is a flowchart illustrating an example of a processing operation according to the first exemplary embodiment. The processing operation illustrated in FIG. 4 is implemented through the execution of a program by the processor 111 (see FIG. 2). The symbol S illustrated in the figure means a step.

When the processor 111 receives a print instruction (step 1), the processor 111 determines whether confirmation before transmission is necessary (step 2). If the confirmation before the transmission is necessary, a positive result (“YES” in step 2) is obtained in step 2, and if the confirmation before the transmission is unnecessary, a negative result (“NO” in step 2) is obtained in step 2.

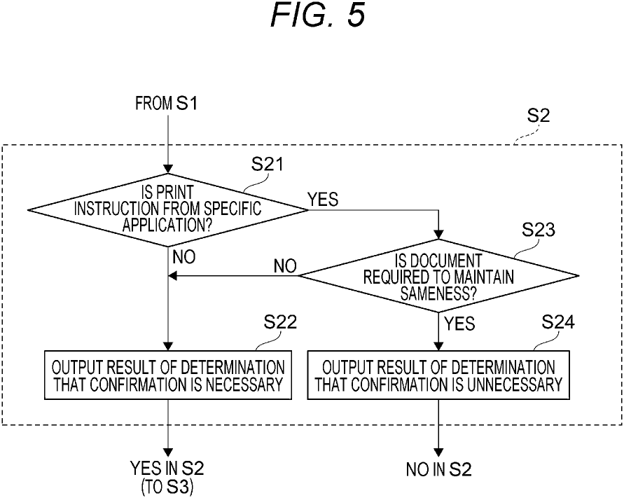

FIG. 5 is a flowchart illustrating an example of a determination operation executed in step 2. The determination illustrated in FIG. 5 is executed as a function of the confirmation necessity determination unit 123 (see FIG. 3).

In FIG. 5, the processor 111 determines whether the print instruction is from a specific application (step 21).

Examples of the specific application include a browser. When a print instruction is received by the browser, the target document is the web page being browsed.

The web page is a document in units of pages, and is configured by a combination of various elements such as characters, images, charts, sound, videos, and programs. Since the web page is a document that is not edited by the user, the confirmation before the transmission is unnecessary. The web page is also an example of a document created by another user.

Outputting a print instruction from a specific application is an example of a case where a predetermined condition is satisfied. Outputting a print instruction from an application other than the specific application is an example of a case where the predetermined condition is not satisfied.

If the print instruction is from an application other than the specific application, a negative result (“NO” in step 21) is obtained in step 21. In this case, the processor 111 outputs the result of the determination that the confirmation is necessary (step 22). This output corresponds to the positive result of step 2.

If the print instruction is from the specific application, a positive result (“YES” in step 21) is obtained in step 21. In this case, the processor 111 determines whether the document is required to maintain the sameness (step 23). Examples of the extension of the document required to maintain the sameness include “pdf” and “xdw”.

A document that is required to maintain the sameness is an example of a case where a predetermined condition is satisfied. The document that is not required to maintain the sameness is an example of a case where a predetermined condition is not satisfied. A document created by another user is also an example of a document required to maintain the sameness. If the information on the creator is included in the attribute of the document, the information on the creator may be acquired by referring to the attribute.

If a document is not required to maintain sameness, a negative result (“NO” in step 23) is obtained in step 23. In this case, the processor 111 outputs the result of the determination that the confirmation is necessary (step 22). This output corresponds to the positive result of step 2.

If a document is required to maintain the sameness, a positive result (“YES” in step 23) is obtained in step 23. In a case where a positive result is obtained in step 23, the processor 111 outputs the result of the determination that the confirmation is unnecessary (step 24). This output corresponds to the negative result of step 2. The document corresponding to the negative result in step 2 is excluded from the display target of the preview image.

The description returns to FIG. 4.

If a positive result is obtained in step 2, the processor 111 calculates the degree of importance (step 3).

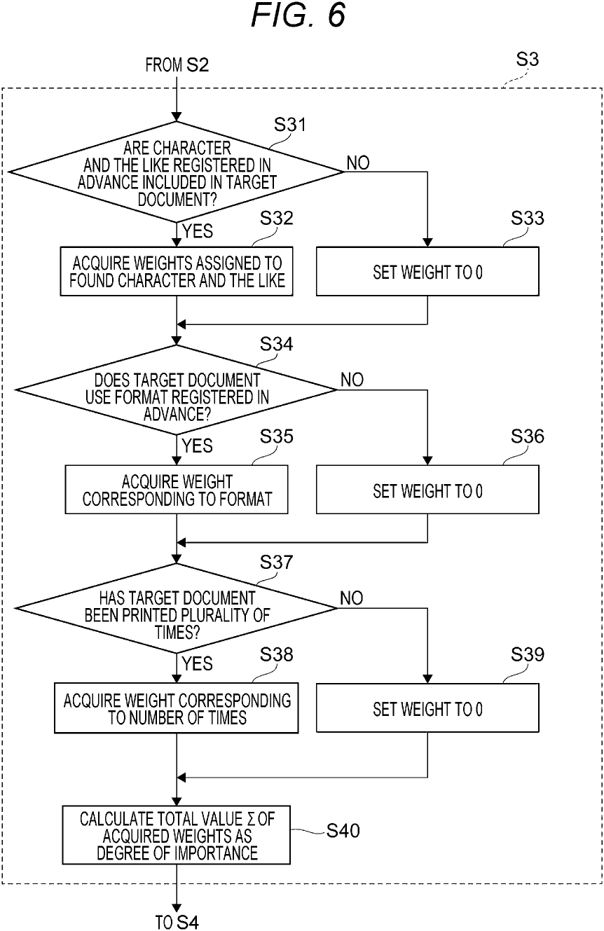

FIG. 6 is a flowchart illustrating an example of the processing operation executed in step 3. The processing operation illustrated in FIG. 6 is executed as a function of the degree-of-importance calculation unit 122 (see FIG. 3).

In FIG. 6, the processor 111 determines whether the character and the like registered in advance are included in the target document (step 31). For example, text search using the character and the like registered in advance as a search key or pattern matching using the character and the like as a reference pattern is executed.

If the target document includes the character and the like registered in advance, a positive result (“YES” in step 31) is obtained in step 31. If a positive result is obtained in step 31, the processor 111 acquires weights assigned to the found character and the like (step 32).

If the target document does not include the character and the like registered in advance, a negative result (“NO” in step 31) is obtained in step 31. If a negative result is obtained in step 31, the processor 111 sets the weight to 0 (step 33).

When step 32 or step 33 is executed, the processor 111 determines whether the target document uses a format registered in advance (step 34). The format registered in advance is registered as, for example, the shape and arrangement of a frame line used in an order form or a contract, a specific character string and arrangement, and the like.

If it is determined that the target document uses the predetermined format, a positive result (“YES” in step 34) is obtained in step 34. If a positive result is obtained in step 34, the processor 111 acquires a weight corresponding to the format (step 35).

If it is determined that the target document does not use the predetermined format, a negative result (“NO” in step 34) is obtained in step 34. If a negative result is obtained in step 34, the processor 111 sets the weight to 0 (step 36).

When step 35 or step 36 is executed, the processor 111 determines whether the target document has been printed a plurality of times (step 37).

If it is determined that the target document has been printed a plurality of times, a positive result (“YES” in step 37) is obtained in step 37. If a positive result is obtained in step 37, the processor 111 acquires a weight corresponding to the number of times (step 38).

If it is determined that the target document is to be printed for the first time, a negative result (“NO” in step 37) is obtained in step 37. If a negative result is obtained in step 37, the processor 111 sets the weight to 0 (step 39).

When step 38 or step 39 is executed, the processor 111 calculates the total value Σ of the acquired weights as the degree of importance (step 40).

The description returns to FIG. 4.

When the degree of importance is calculated in step 3, the processor 111 determines whether the degree of importance is greater than or equal to a reference value (step 4).

If the degree of importance is greater than or equal to the reference value, a positive result (“YES” in step 4) is obtained in step 4. If a positive result is obtained in step 4, the processor 111 displays a preview image (step 5).

Next, the processor 111 determines whether the user has confirmed from the first line to the last line of the target document (step 6). In other words, the processor 111 determines whether the entire target document has been confirmed.

If it is not determined that the user has confirmed from the first line to the last line of the target document, a negative result (“NO” in step 6) is obtained in step 6. If a negative result is obtained in step 6, the processor 111 returns to step 5. That is, the processor 111 continues the preview display of the target document.

If it is determined that the user has confirmed from the first line to the last line of the target document, a positive result (“YES” in step 6) is obtained in step 6. If a positive result is obtained in step 6, the processor 111 determines whether the user has given an instruction to cancel the print instruction (step 7).

If the user cancels the print instruction, a positive result (“YES” in step 7) is obtained in step 7. If a positive result is obtained in step 7, the processor 111 deletes the print job (step 8).

In contrast, if a negative result (“NO” in step 2) is obtained in step 2, if a negative result (“NO” in step 4) is obtained in step 4, or if a negative result (“NO” in step 7) is obtained in step 7, the processor 111 transmits the print job (step 9). That is, the execution of the transmission of the print job is permitted.

A negative result in step 2 is obtained when it is determined that the confirmation before the transmission is unnecessary.

A negative result in step 4 is obtained when the degree of importance is less than the reference value.

A negative result in step 7 is obtained when the user gives an instruction to complete the confirmation of the content or to execute printing.

### <Display Example of User Interface>

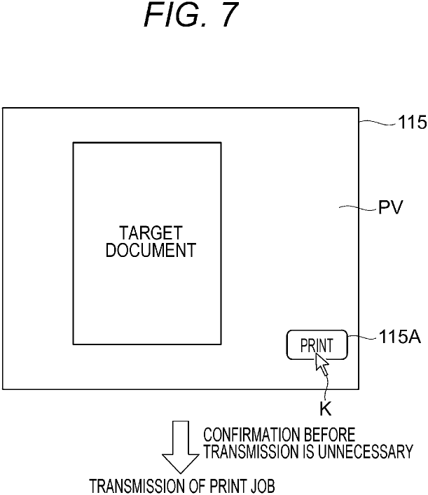

FIG. 7 is a diagram illustrating a case where a preview image of a target document does not need to be displayed.

The display device 115 (see FIG. 2) displays the target document and a “print” button 115A. The user who desires to print the target document clicks the “print” button 115A.

In the example illustrated in FIG. 7, since the confirmation before the transmission is unnecessary, the print job is transmitted without displaying the preview image. As a result, the target document is printed in the image forming apparatus 200 (see FIG. 1).

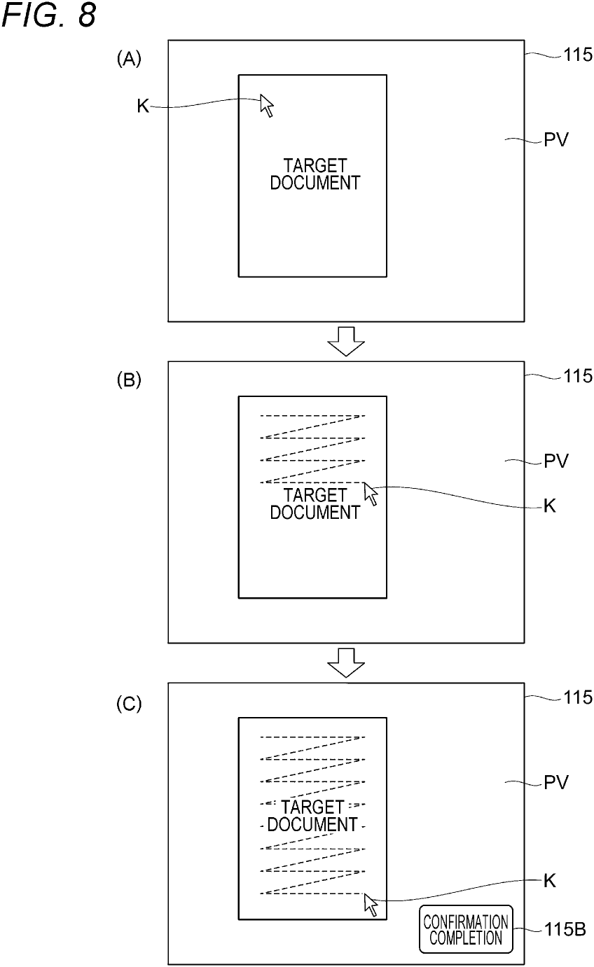

FIG. 8 is a diagram illustrating a display example of a part of a preview image PV displayed on the display device 115 (see FIG. 2). (A) illustrates a display state at the start of confirmation, (B) illustrates a display state during confirmation, and (C) illustrates a display state at the end of confirmation. In FIG. 8, components corresponding to those in FIG. 7 are denoted by the same reference numerals.

FIG. 8 illustrates a case where the preview image PV of the target document is printed on a sheet of paper.

In (A) of FIG. 8, a mouse cursor K is located near the upper left corner of the target document.

In (B) of FIG. 8, the mouse cursor K is located near the right end of the middle of the target document.

In (B) of FIG. 8, the path of the movement of the mouse cursor K after the preview image PV starts to be confirmed is indicated by a broken line. It can be seen that the mouse cursor K located near the upper left corner of the target document is moving along the lines of the target document.

In (C) of FIG. 8, the mouse cursor K is located near the right end of the last line of the target document. Since it is determined, from the path of the movement of the mouse cursor K up to this position, that the entire target document has been confirmed, a “confirmation completion” button 115B appears near the lower right corner of the preview image.

The “confirmation completion” button 115B is not displayed in (A) and (B) of FIG. 8 in which the entire target document has not been confirmed. If the “confirmation completion” button 115B is not displayed, the print job is not transmitted. As described above, in the present exemplary embodiment, not only a preview image of a target document that needs to be confirmed is displayed, but also the entire target document is forced to be actually confirmed by the user. For this reason, the preliminary confirmation with the preview image is less likely to be perfunctory. The “confirmation completion” button 115B is an example of an operator. In the present exemplary embodiment, the preview image is not closed even when the “confirmation completion” button 115B is clicked.

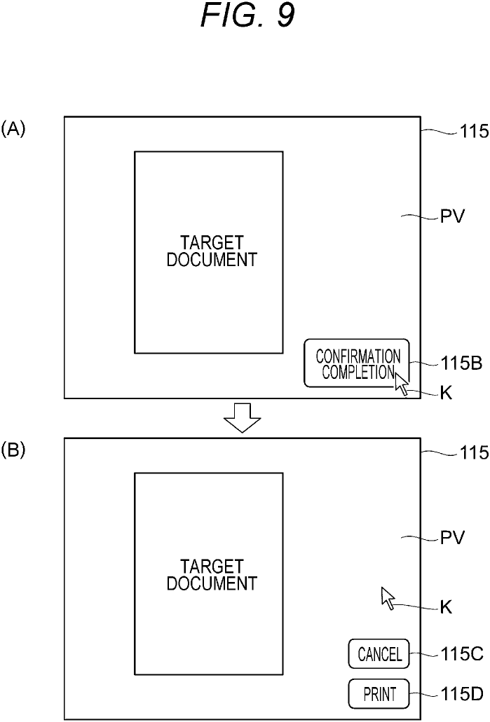

FIG. 9 is a diagram illustrating a remaining display example of the preview image PV displayed on the display device 115 (see FIG. 2). (A) illustrates an operation state of the “confirmation completion” button 115B, and (B) illustrates a display example of the preview image PV subsequent to the operation of the “confirmation completion” button. In FIG. 9, components corresponding to those in FIG. 8 are denoted by the same reference numerals.

In (A) of FIG. 9, the mouse cursor K is located above the “confirmation completion” button 115B. When the “confirmation completion” button 115B is clicked, the display of the preview image PV is changed to (B) of FIG. 9.

In the preview image PV illustrated in (B) of FIG. 9, a “cancel” button 115C and a “print” button 115D are displayed instead of the “confirmation completion” button 115B.

If the “cancel” button 115C is clicked, the print job of the target document is deleted.

If the print job is deleted, the image forming apparatus 200 (see FIG. 1) does not print the target document.

If the “print” button 115D is clicked, the print job of the target document is transmitted to the image forming apparatus 200. That is, the transmission of the temporarily stopped print job is executed. The “cancel” button 115C and the “print” button 115D are examples of operators for closing the preview image.

In a case where the preview image is closed by operating the “confirmation completion” button, the “confirmation completion” button is an example of an operator for closing the preview image.

### Second Exemplary Embodiment

In the second exemplary embodiment, an example in which the preview display is controlled without calculating the degree of importance will be described.

The conceptual configuration of an image forming system described in the second exemplary embodiment is the same as that in the first exemplary embodiment. The hardware configuration of the user terminal 100 (see FIG. 1) is also the same as that in the first exemplary embodiment.

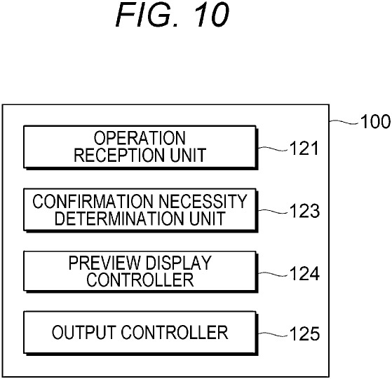

FIG. 10 is a diagram illustrating a functional configuration of the user terminal 100 used in the second exemplary embodiment. In FIG. 10, components corresponding to those in FIG. 3 are denoted by the same reference numerals.

The functional units illustrated in FIG. 10 are the operation reception unit 121, the confirmation necessity determination unit 123, the preview display controller 124, and the output controller 125. The difference from FIG. 3 is that the degree-of-importance calculation unit 122 (see FIG. 3) is not used.

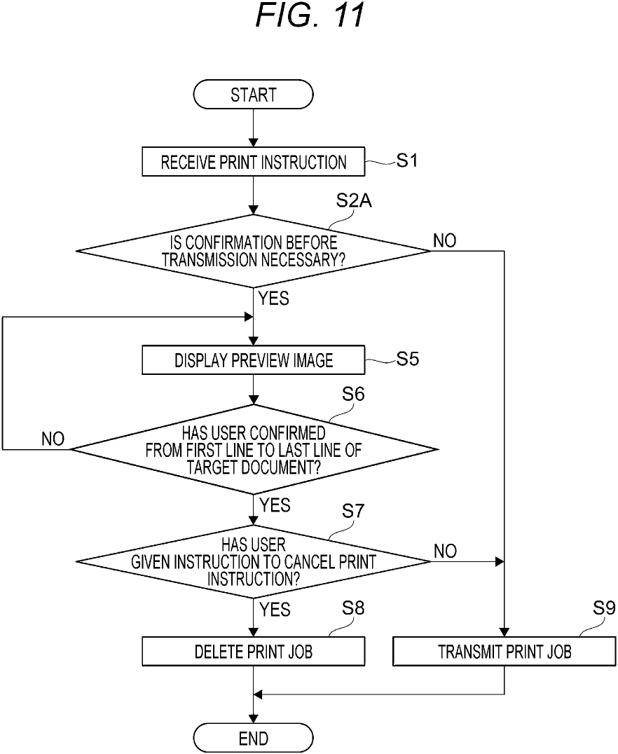

FIG. 11 is a flowchart illustrating an example of a processing operation according to the second exemplary embodiment. In FIG. 11, components corresponding to those in FIG. 4 are denoted by the same reference numerals.

The processing operation illustrated in FIG. 11 is also implemented through the execution of the program by the processor 111 (see FIG. 2). The processing operation illustrated in FIG. 11 does not include steps 3 and 4 (see FIG. 4). That is, in the second exemplary embodiment, if a positive result (“YES” in step 2A) is obtained in step 2A, the processor 111 displays the preview image (step 5). If a negative result (“NO” in step 2A) is obtained in step 2A, the processor 111 transmits a print instruction (step 9).

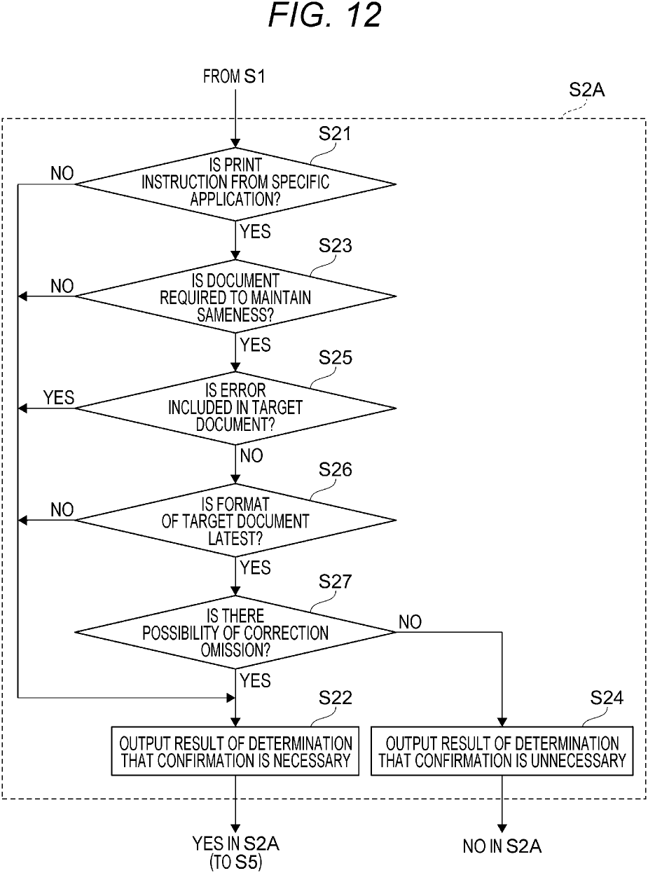

FIG. 12 is a flowchart illustrating an example of a determination operation executed in step 2A. In FIG. 12, components corresponding to those in FIG. 5 are denoted by the same reference numerals. The determination operation illustrated in FIG. 12 is implemented as a function of the confirmation necessity determination unit 123 (see FIG. 3).

If a negative result (“NO” in step 21) is obtained in step 21 or a negative result (“NO” in step 23) is obtained in step 23, the processor 111 proceeds to step 22. The output of step 22 corresponds to the positive result (“YES” in step 2A) of step 2A.

If a positive result (“YES” in step 23) is obtained in step 23, the processor 111 determines whether the target document includes an error (step 25).

Examples of the error include a misspelling, a missing character, an incorrect conversion, and an incorrect proper noun. For example, a calibration function included in a calibration application or an application that receives printing of a target document may be used to find an error.

Alternatively, the possibility that the target document includes an error may be determined based on a predetermined rule regarding the format of the target document.

The rule has a relationship between the date of creation described at a specific position of the target document and the date on which the print instruction is received. For example, there is a rule that requires that a date on which a print instruction can be received is within 7 days from the date of creation of a target document. In this case, if the date on which the print instruction can be received is ten days after the date of creation of the target document, it is determined that the target document includes an error.

If it is determined that the target document includes an error, a positive result (“YES” in step 25) is obtained in step 25. In this case, the processor 111 proceeds to step 22.

If it is determined that the target document does not include an error, a negative result (“NO” in step 25) is obtained in step 25. If a negative result is obtained in step 25, the processor 111 determines whether the format of the target document is the latest (step 26).

As a rule, the determination in step 26 is performed if the target document is required to be printed in the latest format. The latest format is registered in advance in, for example, the auxiliary storage device 114 (see FIG. 2).

If the format of the target document is not the latest, a negative result (“NO” in step 26) is obtained in step 26. If a negative result is obtained in step 26, the processor 111 proceeds to step 22.

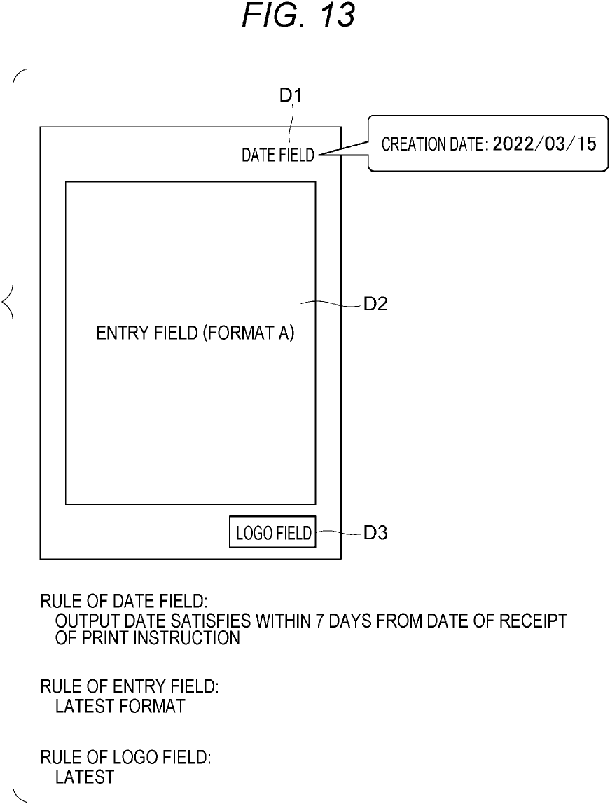

FIG. 13 is a diagram illustrating an example of a format of a target document.

In the format of the target document illustrated in FIG. 13, a date field D1 is arranged at the upper right corner, an entry field D2 described in the format A is arranged in the middle, and a logo field D3 is arranged at the lower right corner.

In the example of FIG. 13, as a rule of the date field D1, “the output date satisfies within 7 days from the date of receipt of the print instruction” is defined.

In FIG. 13, the description in the date field D1 is “2022/03/15”. For example, if the date at which the print instruction is received is “2022/03/31”, the print instruction for the target document does not satisfy the rule. On the other hand, if the date at which the print instruction is received is “2022/03/16”, the print instruction for the target document satisfies the rule.

In the example of FIG. 13, “the latest format” is defined as the rule of the entry field D2. If the format A used in the description in the entry field D2 is not the latest, the print instruction for the target document does not satisfy the rule. On the other hand, if the format A used in the description in the entry field D2 is the latest, the print instruction for the target document satisfies the rule.

In the example of FIG. 13, “latest” is defined as the rule of the logo field D3. If the logo described in the logo field D3 is not the latest, the print instruction for the target document does not satisfy the rule. On the other hand, when the logo described in the logo field D3 is the latest, the print instruction for the target document satisfies the rule.

The description returns to FIG. 12.

If a positive result is obtained in step 26, the processor 111 determines whether there is a possibility of correction omission (step 27). In other words, the processor 111 determines whether the portion to be originally corrected remains uncorrected.

If there is a possibility of correction omission, a positive result (“YES” in step 27) is obtained in step 27. If a positive result is obtained in step 27, the processor 111 proceeds to step 22.

If there is no possibility of correction omission, a negative result (“NO” in step 27) is obtained in step 27. If a negative result is obtained in step 27, the processor 111 proceeds to step 24. The output of step 24 corresponds to the negative result (“NO” in step 2A) of step 2A.

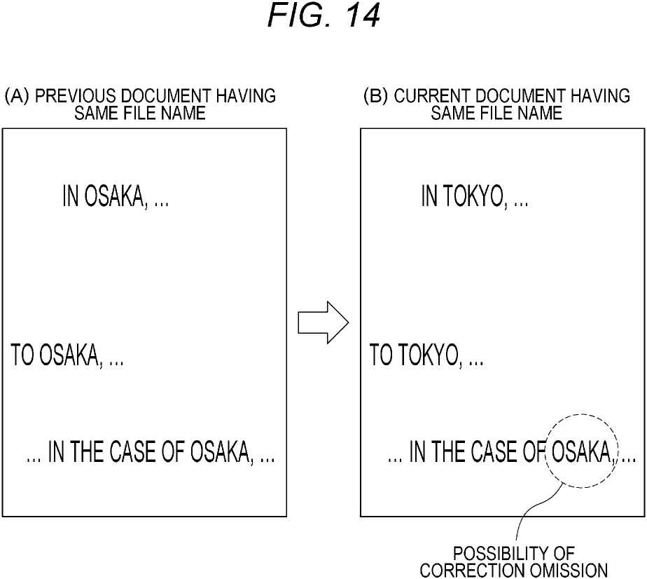

FIG. 14 is a diagram illustrating an example of correction omission. (A) illustrates an example of a previous document having the same file name, and (B) illustrates an example of a current document having the same file name.

Here, the current document illustrated in (B) of FIG. 14 is a result of the user’s correction of “Osaka” at two places to “Tokyo” based on the previous document in (A) of FIG. 14. That is, the state illustrated in (B) of FIG. 14 is the state in which “Osaka” at the beginning of the page and “Osaka” in the middle of the page in the previous document in (A) of FIG. 14 are corrected to “Tokyo”. Here, in the case of determining the possibility of correction omission, the processor 111 compares the previous document with the current document and extracts a correction point. In this example, since “Osaka” at two places in the document is corrected to “Tokyo”, the corrections at two places from “Osaka” to “Tokyo” are recorded as a correction history.

The processor 111 searches for another portion having a syntax similar to the corrected portion by comparing the current document (that is, the target document) with the correction history. If another portion is found, the corresponding portion is detected as a possibility of correction omission.

In (B) of FIG. 14, “in the case of Osaka” is found as a portion similar to the syntaxes of “in Tokyo” and “to Tokyo”. This portion is a portion having a possibility of correction omission.

The description returns to FIG. 11.

In the present exemplary embodiment, if a positive result is obtained in step 2A, the processor 111 displays the preview image as it is (step 5).

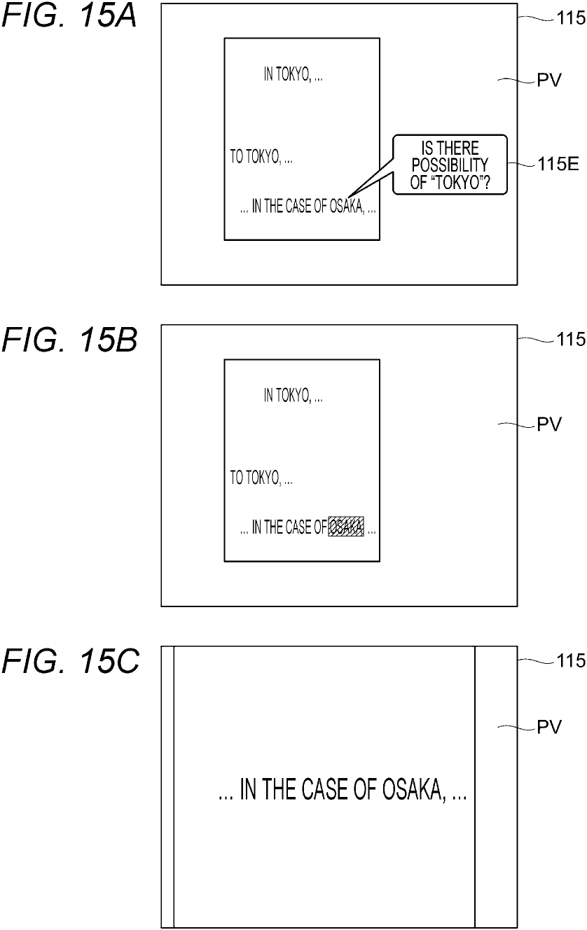

FIGS. 15A to 15C are diagrams each illustrating a display example of a preview image according to the second exemplary embodiment. FIG. 15A illustrates an example in which a correction candidate is displayed at a portion having a possibility of correction omission, FIG. 15B illustrates an example in which the portion having the possibility of correction omission is displayed so as to be distinguishable from other portions, and FIG. 15C illustrates an example in which only the portion having the possibility of correction omission is displayed in an enlarged manner.

The display examples illustrated in FIGS. 15A to 15C each represent a display form for supporting the confirmation of a portion having a possibility of correction omission.

For example, in FIG. 15A, a balloon 115E of “Is there a possibility of ‘Tokyo’?” is displayed at the position of “in the case of Osaka”.

In FIG. 15B, only the position of “Osaka” is shaded.

In FIG. 15C, only several lines before and after “in the case of Osaka” are enlarged. The enlarged display is merely an example, and only the surroundings of “in the case of Osaka” in the target document may be cut out and displayed.

Here, the portion having a possibility of correction omission is an example of a portion having a possibility of error.

### Third Exemplary Embodiment

In a third exemplary embodiment, an example in which completion of confirmation of the target document by the user is detected by tracking the line of sight of the user will be described.

The conceptual configuration of an image forming system described in the third exemplary embodiment is the same as that in the first exemplary embodiment. The hardware configuration of the user terminal 100 (see FIG. 1) is also the same as that in the first exemplary embodiment.

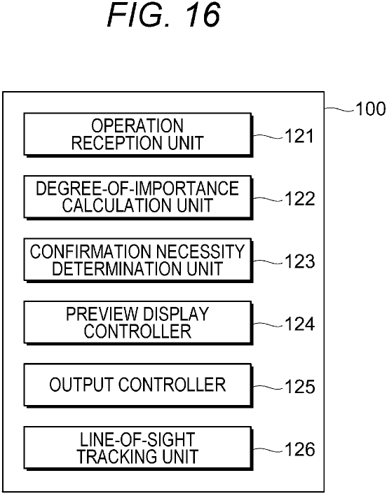

FIG. 16 is a diagram illustrating a functional configuration of the user terminal 100 used in the third exemplary embodiment.

In FIG. 16, components corresponding to those in FIG. 3 are denoted by the same reference numerals.

The functional units illustrated in FIG. 16 are the operation reception unit 121, the degree-of-importance calculation unit 122, the confirmation necessity determination unit 123, the preview display controller 124, the output controller 125, and a line-of-sight tracking unit 126. The difference from FIG. 3 is that the line-of-sight tracking unit 126 is added.

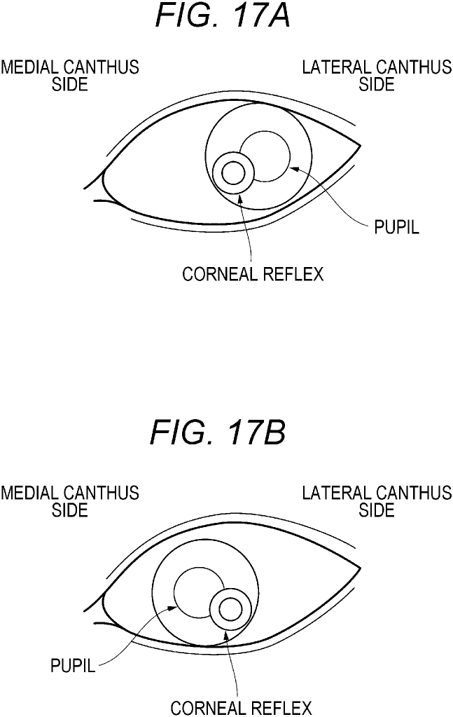

FIGS. 17A and 17B are diagrams each illustrating tracking of a direction of a line of sight of a user who views a preview image.

FIG. 17A illustrates a case where the user is viewing the left side (right side of the preview image), and FIG. 17B illustrates a case where the user is viewing the right side (left side of the preview image).

In a corneal reflex method, for example, a device including an infrared light emitting diode (LED) and an infrared camera is disposed at a position facing the user operating the user terminal 100.

In the corneal reflex method, the direction of the line of sight of the user is detected based on the positional relationship between the pupil and the reflection of the infrared ray from the infrared LED on the cornea (that is, “corneal reflex”).

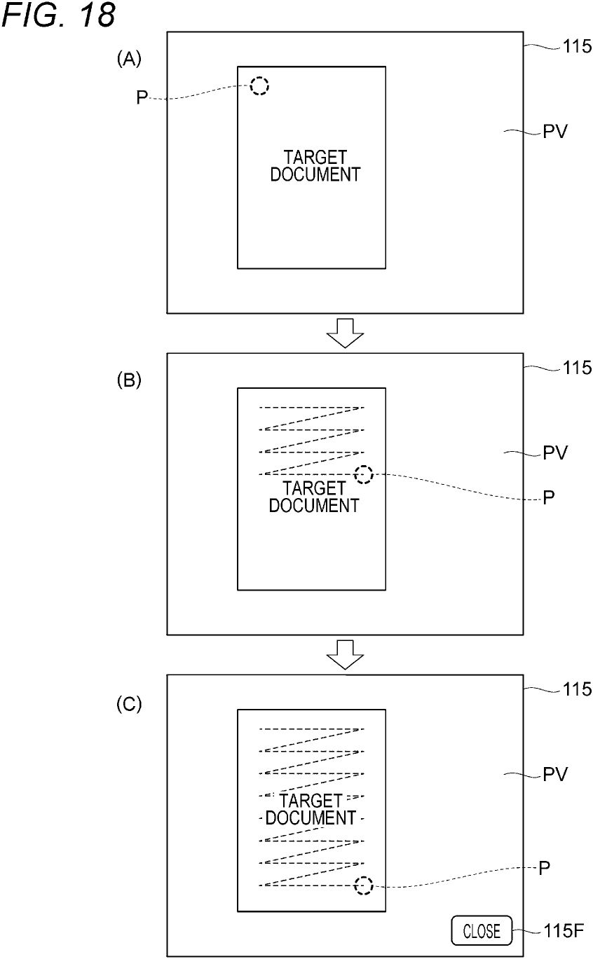

FIG. 18 is a diagram illustrating another display example of the preview image PV displayed on the display device 115 (see FIG. 2). (A) illustrates the position P of the line of sight and the display state at the start of confirmation, (B) illustrates the position P of the line of sight and the display state during confirmation, and (C) illustrates the position P of the line of sight and the display state at the end of confirmation. In FIG. 18, components corresponding to those in FIG. 8 are denoted by the same reference numerals.

FIG. 18 also illustrates a case where the preview image PV of the target document is printed on a sheet of paper.

In (A) of FIG. 18, the position P of the line of sight of the user is located near the upper left corner of the target document.

In (B) of FIG. 18, the position P of the line of sight of the user is located near the right end of the middle of the target document.

In (B) of FIG. 18, the path of movement of the position P of the line of sight of the user after the preview image PV starts to be confirmed is indicated by a broken line. It can be seen that the position P of the line of sight of the user located near the upper left corner of the target document moves along the lines of the target document.

In (C) of FIG. 18, the position P of the line of sight of the user is located near the right end of the last line of the target document. Since it is determined, from the path of the movement of the position P of the line of sight of the user up to this position, that the entire target document has been confirmed, a “close” button 115F appears near the lower right corner of the preview image. The “close” button 115F is a button for closing the preview image.

### Fourth Exemplary Embodiment

In a fourth exemplary embodiment, a case where a document output from the user terminal 100 is an email or a message will be described.

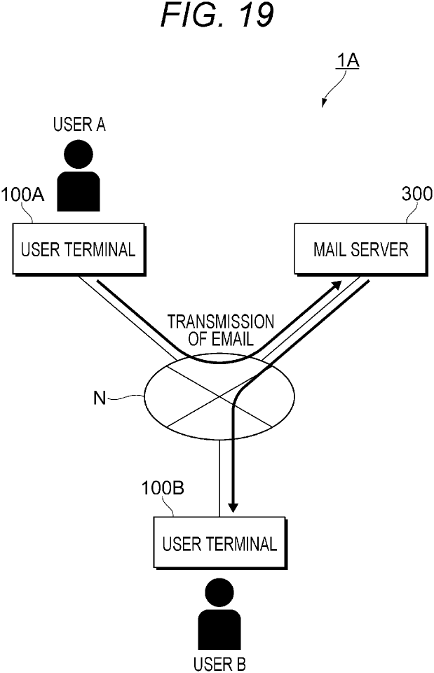

FIG. 19 is a conceptual diagram of a network system 1A according to the fourth exemplary embodiment. In FIG. 19, components corresponding to those in FIG. 1 are denoted by the same reference numerals.

The network system 1A illustrated in FIG. 19 includes user terminals 100A and 100B and a mail server 300 that are communicably connected via the network N.

The user terminal 100A is a terminal operated by a user A, and the user terminal 100B is a terminal operated by a user B. In a case where the user is not distinguished, the user terminals 100A and 100B are referred to as the user terminal 100.

In FIG. 19, for convenience of description, two user terminals 100A and 100B and one mail server 300 are connected to the network N, but three or more user terminals 100 and a plurality of mail servers 300 may be connected to the network N.

The user terminal 100 is an example of an information processing apparatus.

A hardware configuration and a functional configuration of the user terminal 100 used in the fourth exemplary embodiment are the same as those in the other exemplary embodiments described above.

In the fourth exemplary embodiment, the “print job” in the other exemplary embodiments described above is replaced with a “transmission job” of an email or a message.

The transmission of email or the like is received by an application that handles email or the like (hereinafter, also referred to as a “mailer”). The email or the like is an example of an electronic document, and is an example of a target document.

If the user terminal 100 in the present exemplary embodiment receives transmission of the email or the like, it is determined whether confirmation is necessary before transmitting the email to the mail server 300.

The processing operation of determining the necessity of the confirmation may be the same as that in the first exemplary embodiment or the like.

As in the first exemplary embodiment, the calculation of the degree of importance or the confirmation of the entire target document are also set as the conditions for closing the preview image.

A document to be attached to an email or the like may be included in a target to be confirmed before transmission of the email or the like.

In the present exemplary embodiment, a preview image is displayed only when an error is included in an email or the like, thereby enhancing the effect of suppressing erroneous transmission. In addition, since it is required to confirm the entirety of the target document displayed on the preview image in order to execute the transmission of email or the like, the confirmation of the content using the preview image is less likely to be perfunctory.

### Fifth Exemplary Embodiment

In a fifth exemplary embodiment, a case will be described in which a document is transmitted from the image forming apparatus 200.

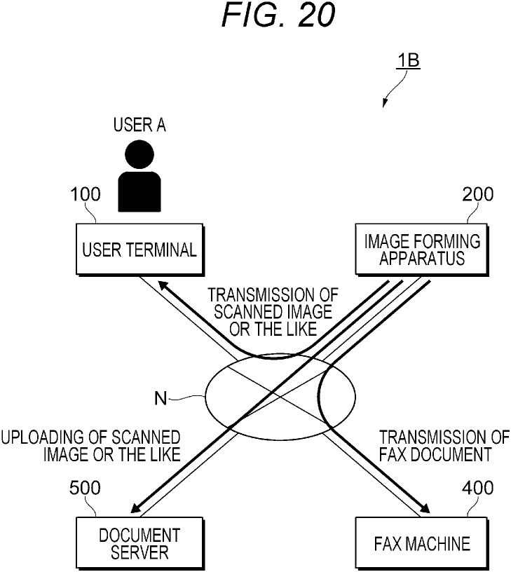

FIG. 20 is a conceptual diagram of a network system 1B according to a fifth exemplary embodiment. In FIG. 20, components corresponding to those in FIG. 1 are denoted by the same reference numerals.

The network system 1B illustrated in FIG. 20 includes the user terminal 100, the image forming apparatus 200, a fax machine 400, and a document server 500 that are communicably connected via a network N.

Although one user terminal 100, one image forming apparatus 200, one fax machine 400, and one document server 500 are connected to the network N in FIG. 20 for convenience of explanation, a plurality of user terminals 100 and the like may be connected to the network N.

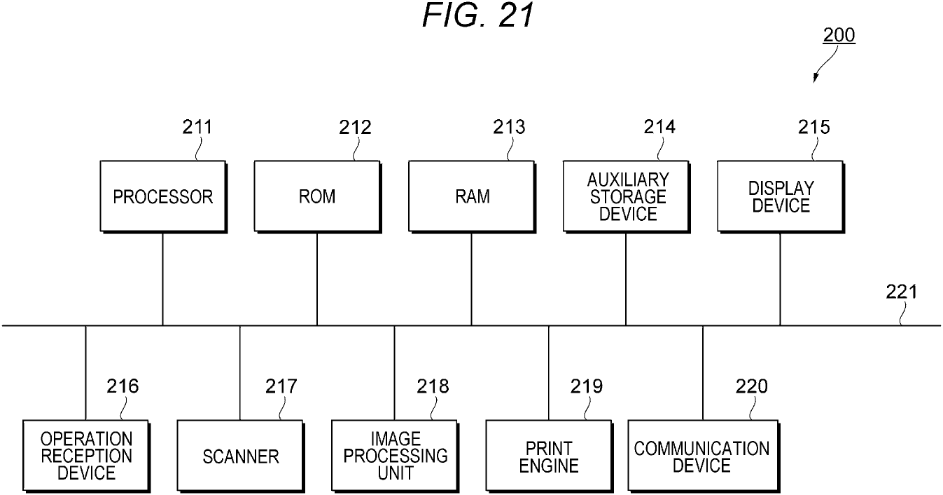

FIG. 21 is a diagram illustrating a hardware configuration of the image forming apparatus 200.

The image forming apparatus 200 illustrated in FIG. 21 includes a processor 211 that controls an operation of the entire apparatus, a ROM 212 that stores a BIOS or the like, a RAM 213 used as a work area of the processor 211, an auxiliary storage device 214 that stores image data, print data, or the like, a display device 215 that displays a user interface, an operation reception device 216 that receives a user operation, a scanner 217 that reads an image of a document, an image processing unit 218 that performs processing such as color correction and tone correction on image data, a print engine 219 that prints an image on paper or another medium, and a communication device 220 that implements communication with the network N. The processor 211 and other processing units are connected to each other using a communication path 221.

The processor 211, the ROM 212, and the RAM 213 function as a so-called computer.

The processor 211 implements various functions through execution of a program. One of the functions herein is a function of selectively executing preview display before transmission of a scanned image, a fax image, or the like. The scanned image or the fax image corresponds to the target document in the exemplary embodiments described above.

For example, the processor 211 implements a function of determining whether confirmation is necessary for the target document, transmitting the target document if confirmation is unnecessary, and displaying the target document on a preview image if confirmation is necessary.

The processing operation of determining the necessity of the confirmation may be the same as that in the first exemplary embodiment or the like.

As in the first exemplary embodiment, the calculation of the degree of importance or the confirmation of the entire target document are also set as the conditions for closing the preview image.

Examples of the auxiliary storage device 214 include a semiconductor memory and a hard disk drive.

The display device 215 is, for example, a liquid crystal display or an organic EL display.

The operation reception device 216 is a capacitive touch sensor disposed on the surface of the display device 215 in addition to a physical switch and button. A device in which the display device 215 and the operation reception device 216 are integrated is called a touch panel.

The scanner 217 supports both a mode in which an image is read while moving a reading unit relative to a stationary document and a mode in which an image is read while moving a document relative to a stationary reading unit.

The image processing unit 218 includes a dedicated processor, processing circuit, and the like for processing image data and print data.

The print engine 219 is a device that forms an image on a medium such as paper, and includes a mechanism according to a printing method. Examples of the recording material include toner and ink.

The communication device 220 is a device that implements communication with the network N, and includes a module conforming to a wired or wireless communication standard.

The communication path 221 is a signal line or a bus.

The description returns to FIG. 20.

In the present exemplary embodiment, the image forming apparatus 200 operates as a terminal that transmits a scanned image or a fax image. The image forming apparatus 200 is an example of an information processing apparatus.

For this reason, the image forming apparatus 200 in the present exemplary embodiment has a function of determining necessity of confirmation by the user prior to execution of transmission of a scanned image or the like to the user terminal 100, transmission of a fax document to the fax machine 400, and uploading of a scanned image or the like to the document server 500.

According to this function, as in the above-described exemplary embodiments, a preview image can be displayed only when it is determined that confirmation is necessary. In addition, since the transmission is not executed until the user confirms the entire target document, it is possible to prevent the transmission and upload of the document including the error in advance.

Further, since the display of the preview image is performed only when the user needs to confirm the target document, the confirmation of the target document does not become perfunctory.

### Sixth Exemplary Embodiment

Although, in the exemplary embodiments described above, an operator for closing the preview image of the target document is displayed on the preview display controller 124 when it is estimated that confirmation of the entire preview image of the target document has been completed, the preview image of the target document may be continuously displayed until it is estimated that confirmation of the entire preview image of the target document has been completed in another exemplary embodiment. In this case, by providing a function of closing the preview image when it is estimated that the user has confirmed the entire preview image of the target document by the movement of the mouse cursor or the movement of the line of sight of the user, or by providing a function of closing the preview image when a predetermined time has elapsed after it is estimated that the user has confirmed the entire preview image of the target document, it is possible to proceed to the subsequent process. According to the exemplary embodiment employing such a configuration, there is an effect that the following processing can be executed without causing the user to operate the operator for closing the preview image.

### Other Exemplary Embodiments

(1) Although the exemplary embodiments of the present invention have been described above, the technical scope of the present invention is not limited to the scope of the exemplary embodiments described above. It is clear from the descriptions in the claims that a variety of modifications or improvements may be made to the foregoing exemplary embodiment and such modifications and improvements may also fall within the technical scope of the present invention.

(2) The processor in each of the above-described exemplary embodiments refers to a processor in a broad sense, and includes a general-purpose processor (for example, a CPU) and a dedicated processor (for example, a graphical processing unit (GPU), an application specific integrated circuit (ASIC), a field programmable gate array (FPGA), a program logic device, and the like).

In addition, the operation of the processor in each of the above-described exemplary embodiments may be executed by one processor alone, but may be executed by a plurality of physically separated processors in cooperation with each other. In addition, the order in which the processor executes each operation is not limited to the order described in each of the above-described exemplary embodiments, and may be individually changed.

What is claimed is:

1. A non-transitory computer readable recording medium recording a program for causing a computer to implement:
a function of displaying a preview image of a document instructed to be output prior to execution of output of the document in a case where a content of the document satisfies a predetermined condition; and
a function of permitting the execution of output of the document in a case where confirmation by a user of the preview image displayed is detected.

2. The non-transitory computer readable recording medium recording a program according to claim 1,
wherein the predetermined condition is that an evaluation value related to the content of the document is higher than a reference value.

3. The non-transitory computer readable recording medium recording a program according to claim 2,
wherein the evaluation value is calculated as a sum of weights to be assigned in a case where a character registered in advance or a figure registered in advance is included.

4. The non-transitory computer readable recording medium recording a program according to claim 2,
wherein the evaluation value is calculated using a weight assigned in a case where a format registered in advance is used.

5. The non-transitory computer readable recording medium recording a program according to claim 2,
wherein in a case where the instruction to output the document is received after at least one such instruction from a same user, the evaluation value is corrected to a smaller value as the number of instructions received is larger.

6. The non-transitory computer readable recording medium recording a program according to claim 1,
wherein the predetermined condition is that a format of the document does not satisfy a rule.

7. The non-transitory computer readable recording medium recording a program according to claim 6,
wherein the rule is defined for a specific description appearing at a specific position of the format.

8. The non-transitory computer readable recording medium recording a program according to claim 6,
wherein the rule is that the document is created in a latest format.

9. The non-transitory computer readable recording medium recording a program according to claim 1,
wherein the predetermined condition is that a possibility of correction omission is detected by checking a correction history for a document having a file name same as that of the document to be output.

10. The non-transitory computer readable recording medium recording a program according to claim 9,
wherein the possibility of the correction omission is affirmed in a case of a different description in a syntax similar to that in the correction history.

11. The non-transitory computer readable recording medium recording a program according to claim 1 for causing the computer to further execute a function of excluding the document from a display target of the preview image in a case where the document is required to maintain sameness.

12. The non-transitory computer readable recording medium recording a program according to claim 11,
wherein the document required to maintain the sameness is a document created by another user.

13. The non-transitory computer readable recording medium recording a program according to claim 1 for causing the computer to further execute a function of displaying an operator for closing the preview image in a case where confirmation of entirety of the preview image is estimated.

14. The non-transitory computer readable recording medium recording a program according to claim 13,
wherein the confirmation is estimated based on a movement of a mouse cursor on the preview image.

15. The non-transitory computer readable recording medium recording a program according to claim 13,
wherein the confirmation is estimated based on a movement of a line of sight of the user who views the preview image.

16. The non-transitory computer readable recording medium recording a program according to claim 1 for causing the computer to further execute a function of supporting confirmation of a portion having a possibility of an error in the preview image.

17. The non-transitory computer readable recording medium recording a program according to claim 16,
wherein the function of supporting includes displaying only the portion having the possibility of the error as the preview image.

18. The non-transitory computer readable recording medium recording a program according to claim 16,
wherein the function of supporting includes displaying the portion having the possibility of the error in the preview image in a manner distinguishable from other portions.

19. The non-transitory computer readable recording medium recording a program according to claim 16,
wherein the function of supporting includes displaying a correction candidate corresponding to the portion having the possibility of the error.

20. An information processing apparatus comprising a processor,
wherein the processor
displays a preview image of a document instructed to be output prior to execution of output of the document in a case where a content of the document satisfies a predetermined condition, and
permits the execution of output of the document in a case where confirmation by a user of the preview image displayed is detected.

21. An information processing method that is executed by a processor that receives an output of a document, the method comprising,
by the processor:
displaying a preview image of a document instructed to be output prior to execution of output of the document in a case where a content of the document satisfies a predetermined condition; and
permitting the execution of output of the document in a case where confirmation by a user of the preview image displayed is detected.
